(19) United States
(12) Patent Application Publication
(10) Pub. No.: US 2022/0197983 A1
(43) Pub. Date: Jun. 23, 2022

(54) SYSTEMS AND METHODS FOR CREATING AND MANAGING PROGRAMMABLE ART

(71) Applicant: Asynchronous Art, Inc,, San Francisco, CA (US)

(72) Inventors: Conlan Parker Malubag Rios, San Francisco, CA (US); Nathan Clapp, Malden, MA (US); Lisa Liang, Milpitas, CA (US)

(21) Appl. No.: 17/553,778

(22) Filed: Dec. 16, 2021

Related U.S. Application Data
(60) Provisional application No. 63/126,928, filed on Dec. 17, 2020.

(51) Int. Cl. G06F 21/16; H04L 9/32

(52) U.S. Cl. CPC G06F 21/16; H04L 9/3247

(57) ABSTRACT

Systems and methods for creating programmable art are disclosed herein. In one embodiment, a computer-implemented method for creating programmable art, comprising: receiving, at one or more processors, a data package comprised of at least one image and image details from a user, wherein the data package further comprises a set of properties and logic for the image and image details thereby creating a piece of programmable art; reviewing, at the one or more processors, the package for compliance issues; creating, at the one or more processors, a cryptographic token linked to the data package upon receipt of a whitelisted cryptographic signature from the user; and updating, at the one or more processors, a smart contract stored on a distributed ledger network with the cryptographic token and data package.

### CROSS-REFERENCE TO RELATED PATENT APPLICATIONS

This application claims priority under 35 U.S.C. § 119 to U.S. Provisional Application No. 63/126,928, filed Dec. 17, 2020 and entitled “Systems and Methods for Creating and Managing Programmable Art,” the entire disclosure of which is hereby incorporated by reference as if fully set forth herein.

### FIELD OF DISCLOSURE

This invention relates generally to systems and methods for creating and managing programmable art. In particular, systems and methods are described herein for allowing a user to interact with a distributed ledger network to create a piece of programmable art.

### BACKGROUND

Computers have long been used to display representations of artwork, and artwork can be created in an entirely digital manner. That said, digital pieces of artwork often suffer from questions of provenance and a lack of interactivity.

### DESCRIPTION OF DRAWINGS

The figures described below depict various embodiments, features, and aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts an exemplary system for creating and managing programmable art.

FIG. 2 depicts an exemplary workflow for creating and managing programmable art.

FIG. 3 is an exemplary view of a piece of programmable art.

FIG. 4 is an exemplary view of a piece of programmable art.

FIG. 5 is an exemplary view of a piece of programmable art.

FIG. 6A is an exemplary view of a piece of programmable art.

FIG. 6B is an exemplary view of a piece of programmable art.

FIG. 7 is a block diagram of a token manipulation system for interacting with programmable art.

FIG. 8 is a block diagram of a computer-implemented method for creating programmable art.

The figures depict aspects of the present embodiments for purposes of illustration only. One skilled in the art will readily recognize from the following discussion that alternate aspects of the structures and methods illustrated herein may be employed without departing from the principles of the invention described herein.

### DETAILED DESCRIPTION OF THE INVENTION

The present disclosure relates generally to systems and methods for creating and managing programmable art. In particular, systems and methods are described herein for allowing a user to interact with a distributed ledger network to create a piece of programmable art.

In one embodiment, a computer-implemented method for creating programmable art, comprises: receiving, at one or more processors, a data package comprised of at least one image and image details from a user; reviewing, at the one or more processors, the package for compliance issues; creating, at the one or more processors, a cryptographic token linked to the data package upon receipt of a whitelisted cryptographic signature from the user; and updating, at the one or more processors, a smart contract stored on a distributed ledger network with the cryptographic token and data package.

The systems and methods disclosed herein may be thought of as enabling the creation of “programmable art.” Programmable art may be a protocol that creators can use to deconstruct their digital media into “layers” and then grant exclusive control over said layers to individual collectors. The interaction of users, creators, and viewers with the layers and the programmable art may be done through transactions sent to a smart contract stored and executed on a distributed ledger network. In some embodiments, the programmable art may be viewed through an application that utilizes a renderer that monitors the programmable art for changes. In some embodiments, the distributed ledger network may be the Ethereum blockchain network.

When a layer is owned, the collector can invoke abilities such as positional, rotational, transparency, color change, scale, or state change on the layer and the overall composition (“master”) is updated to reflect the latest changes. The collector may also provide titles and descriptions for each layer. State changes may be dependent upon external events that are triggered via transactions with the smart contract.

In this manner, creators of programmable art may have strong control over the boundaries and limitations of the abilities for manipulation of their pieces of programmable art so that collectors are not allowed to stray outside of the creator's original vision of the piece.

In some embodiments, there may be two parts to the protocol: the smart contract which holds the current state and owner(s) of all the layers; and the renderer, an image processing software program which can be run by anyone to view the overall composition of the master work.

These pieces of programmable art may be accessed via a website for collectors to buy, sell, and trade their layers and for creators to create programmable art pieces. A service may run on a server that runs a renderer which constantly monitors the piece of programmable art for layer changes and re-renders the piece once a change has been detected.

The systems and methods described herein enable a variety of uses cases. Users of the systems and methods may be able to enjoy distributed ownership of digital artwork where different components can now be jointly or separately owned by different owners or collectors. For example, one collector may own the hair of an artist's portrait while another might own the smile and so forth.

A potential use case is that of AI controlled paintings. Since collectors may now change artwork through a digital medium, a server running a piece of AI code may monitor real world events and news and change a piece of artwork based on those.

Additionally, a user of the systems and methods described herein may visit a digital art installation in a museum and push a change with a mobile phone, i.e. send a transaction to a smart contract that controls a piece of artwork in the museum, and see the artwork change in front of them. Similarly, a user of the systems and methods described herein may walk by a digital billboard on the street and push a change with a mobile phone and see the billboard image change in front of them, or they may view a piece of digital art on a web site and push a change with a mobile phone or computer and see the art on the website change in front of them.

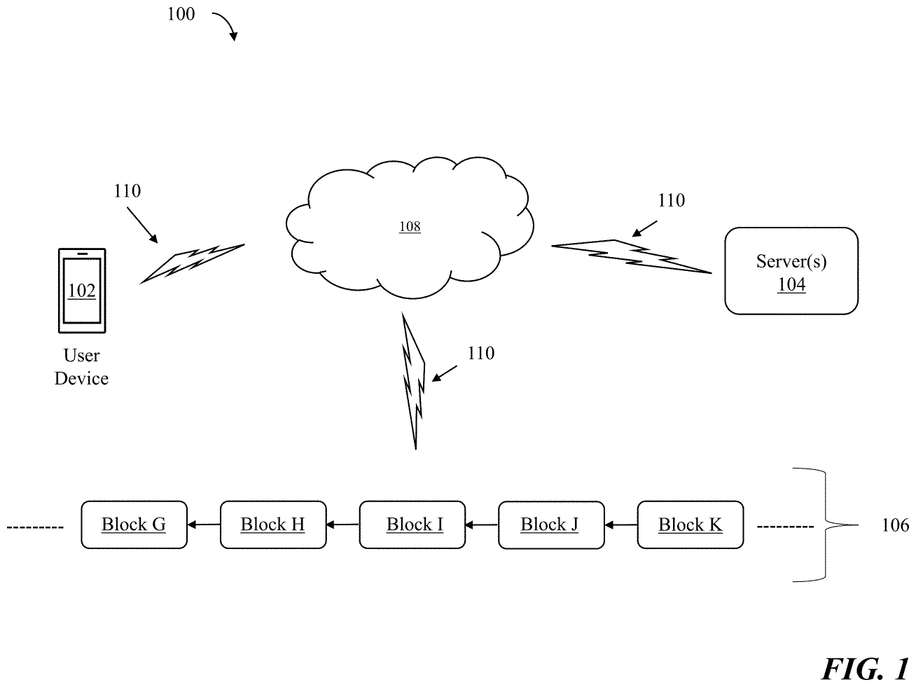

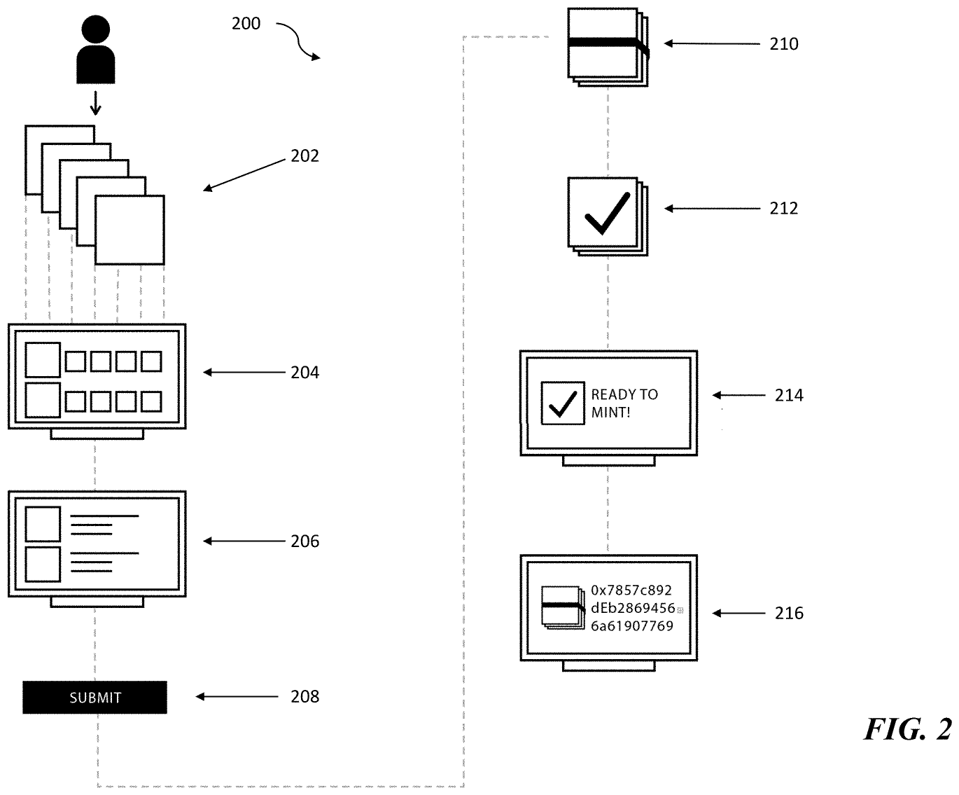

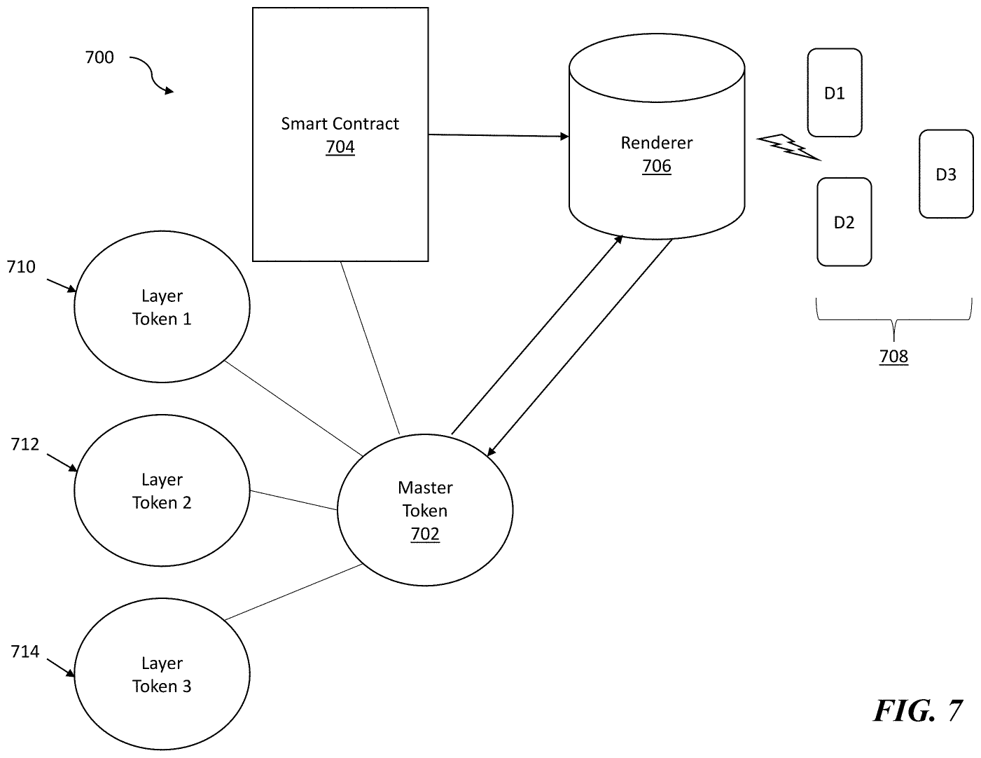

FIG. 1 depicts a system 100 for creating and managing programmable art. The system 100 may comprise a user device 102, one or more server(s) 104, a distributed ledger network 106, a network 108, and one or more network connections 110. In some embodiments of the system 100 there may be additional, or fewer, components to the system. The system may employ a workflow such as the workflow shown and described with reference to FIG. 2 and discussed herein. Similarly, the components of the system 100 may employ a workflow similar to that depicted in FIG. 7 and described herein. The components of the system 100 may be communicatively coupled together to facilitate information exchange to effectuate the functionality discussed herein.

In some embodiments of the system 100, a user of the user device 102 may wish to create a new piece of programmable art. The user may be a subscriber to a service that provides the functionality of creating and interacting with pieces of programmable art via a downloadable application. The user may select a plurality of images to be uploaded through the application downloaded to the user device 102. Once the images are uploaded the user may arrange the images into different layers. These layers may be combined according to the user specified arrangement to create a master layer that represents a piece of art. The user may also add descriptions, cover images, and additional details to each layer as well as the master layer.

After finalizing the arrangement and any details about the piece of art the user may submit the piece of art as a data package to a service for inclusion in a distributed ledger network smart contract. The service may comprise at least one application for enabling the functionality described herein. The data package may be transmitted from the user device 102 to a server(s) 104 via the network 108 and network connections 110. After receiving the data package at the server(s) 104 the service may review the data package for any terms of service or intellectual property issues (e.g. checking the images uploaded for copyrighted images protected or owned by others, etc.) posed by the piece of art embodied in the data package. If no issues are raised by the review the service approves the submission. The user may receive a notification from the service via the system 100 that their piece has been approved.

As a final step the service may request a signature from the user to sign the data package with a whitelisted public distributed ledger network address. A whitelisted address is an address stored at the smart contract that has the necessary permission to call a mint token function. Similarly, a whitelisted address may be any address that is approved by a check against a blacklist of public distributed ledger network addresses that may be compiled by government, non-governmental, or corporate entities to ensure transactions are not originating from blacklisted parties. If the address is whitelisted a token associated with the piece of art is minted at a smart contract stored on the distributed ledger network 106.

FIG. 2 depicts an exemplary workflow 200 for creating and managing programmable art. A user may create or gather a plurality of images they wish to comprise the piece of programmable art at 202. The user may then upload and organize these images through an interface at 204. This interface may provided as part of a service that is offered to a user through a downloadable application, a website, or through a downloadable mobile application, such as the mobile application described above. The user may then add descriptions, cover images, and any additional details about each image and the composition image at 206. The user may then submit the packaged image with details to the service at 208.

The service receives the packaged submission at 210 from the user. The service may then perform a check to ensure that the submission complies with the terms of service for the service, and the package does not violate any intellectual rights at 212. If the submission is approved the user receives a notification at 214. Then the service verifies that the user has signed their submission with a whitelisted public distributed ledger network address, and mints a new token associated with the programmable art at a smart contract stored at the public distributed ledger network address at 216.

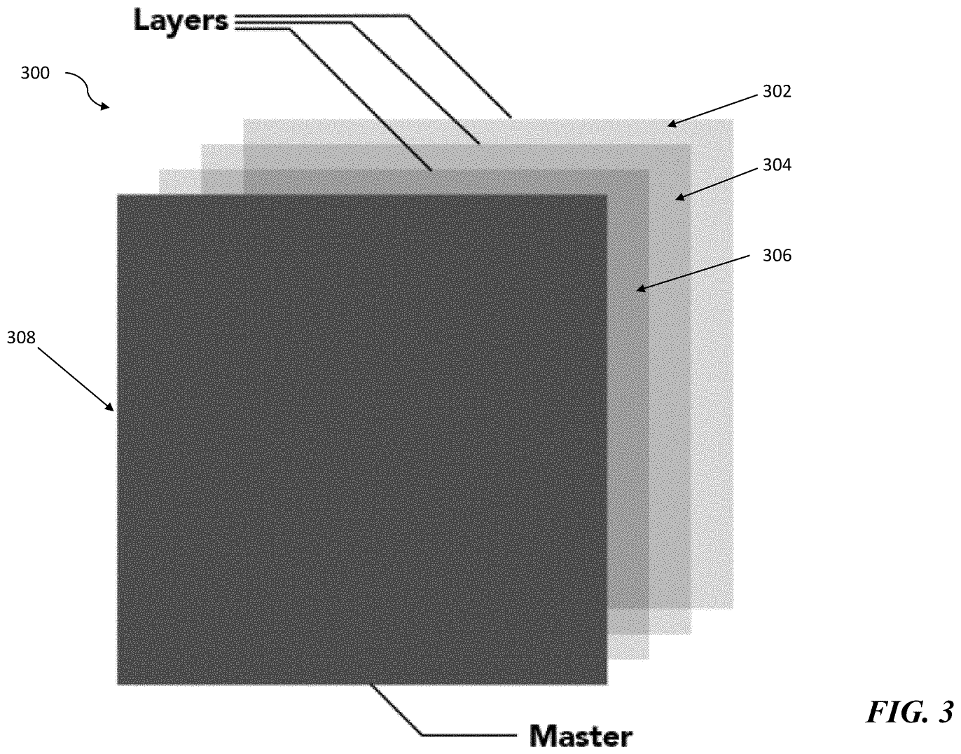

FIG. 3 is an exemplary view 300 of a piece of programmable art. The view 300 showcases a master 308 and several layers 302, 304, and 306 of the programmable art. The systems and methods described herein allow for users to create artworks that are made up of these masters and layers.

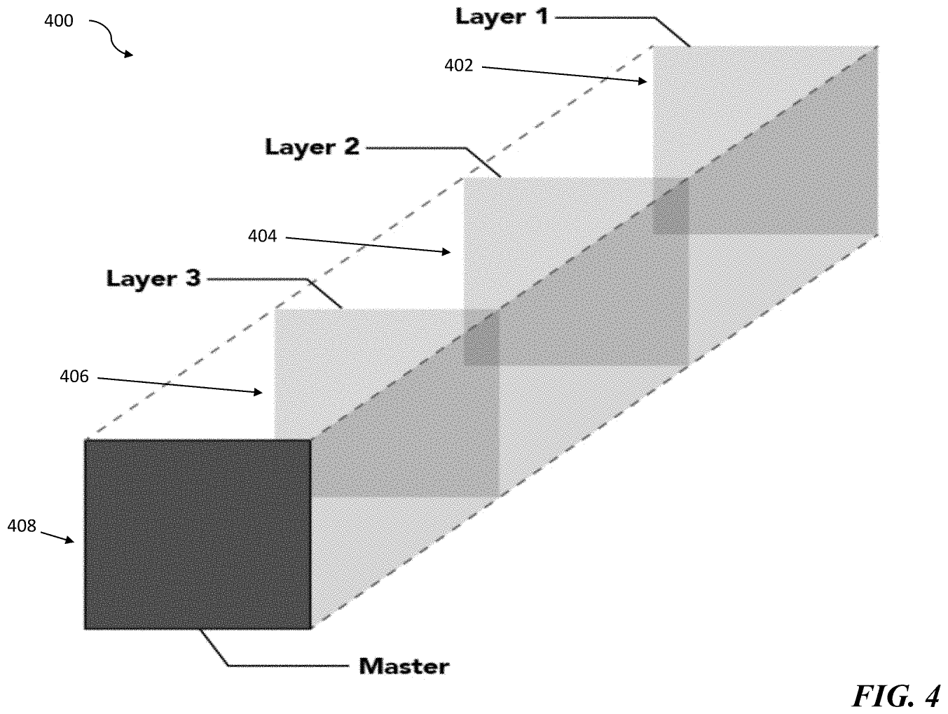

FIG. 4 is an exemplary elongated view 400 of a piece of programmable art. The view 400 showcases a master image 408 and several layers 402, 404, and 406 of the programmable art. In some embodiments, there may additional, or fewer layers than depicted here. The systems and methods described herein allow for users to create artworks that are made up of these masters and layers. A single piece of programmable art may be comprised of the layers 402, 404, and 406, and put together they stack up to create the master image 408.

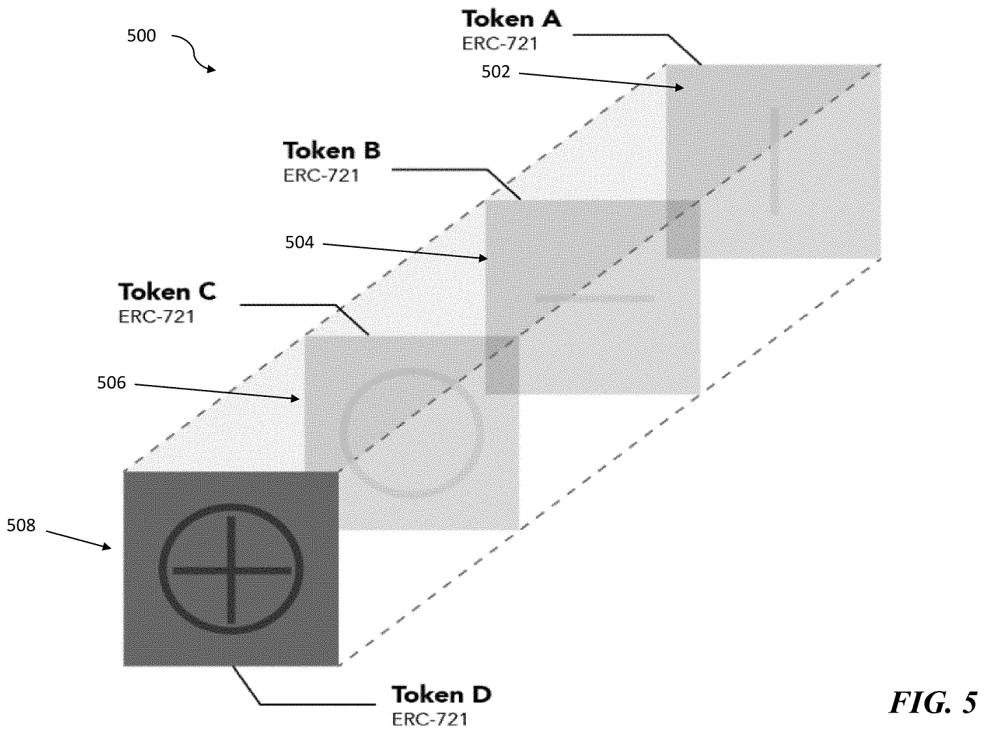

FIG. 5 is an exemplary elongated view 500 of a piece of programmable art. The view 500 showcases a master image 508 and several layers 502, 504, and 506 of the programmable art. In some embodiments, each layer 502, 504, and 506 may be represented by an ERC-721 token that allows for users to verify the layers' uniqueness and makes the layers non-fungible. The master image 508 may also be represented by an ERC-721 token. The master image 508 may include instructions in it that explain which unique layer tokens comprise the master image 508 itself, as well as the order in which they should be displayed. For example, the instructions may determine that the “front” layer is layer 506, with layer 504 being behind layer 506 and layer 502 being behind layer 504.

In embodiments where the layers and master image are represented by ERC-721 tokens each layer and Master are backed by ERC-721 tokens. These may be non-fungible digital assets that run on an open-source network, such as, for example, the Ethereum blockchain network. In some embodiments, these tokens may ensure scarcity. They may also hold the information for who the owner of the token is, what images are associated with the token, when the token was created, and a proof of creation signature from the artist. They also enforce rules around only allowing layer owners to make a change. In some embodiments, for someone to submit a change, they may need to sign a transaction from the same address that holds the token for that layer.

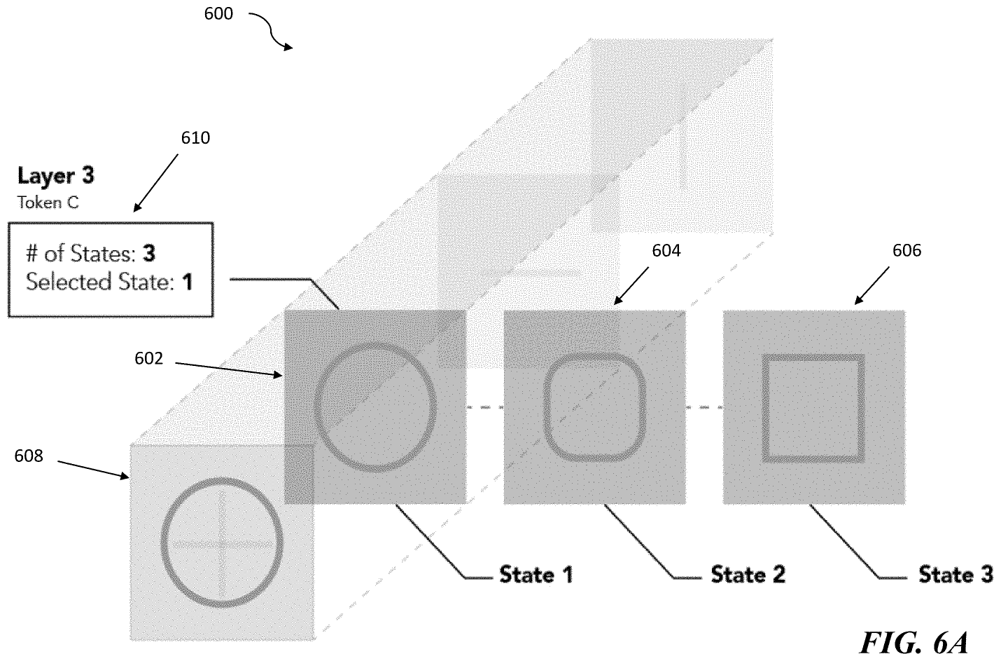

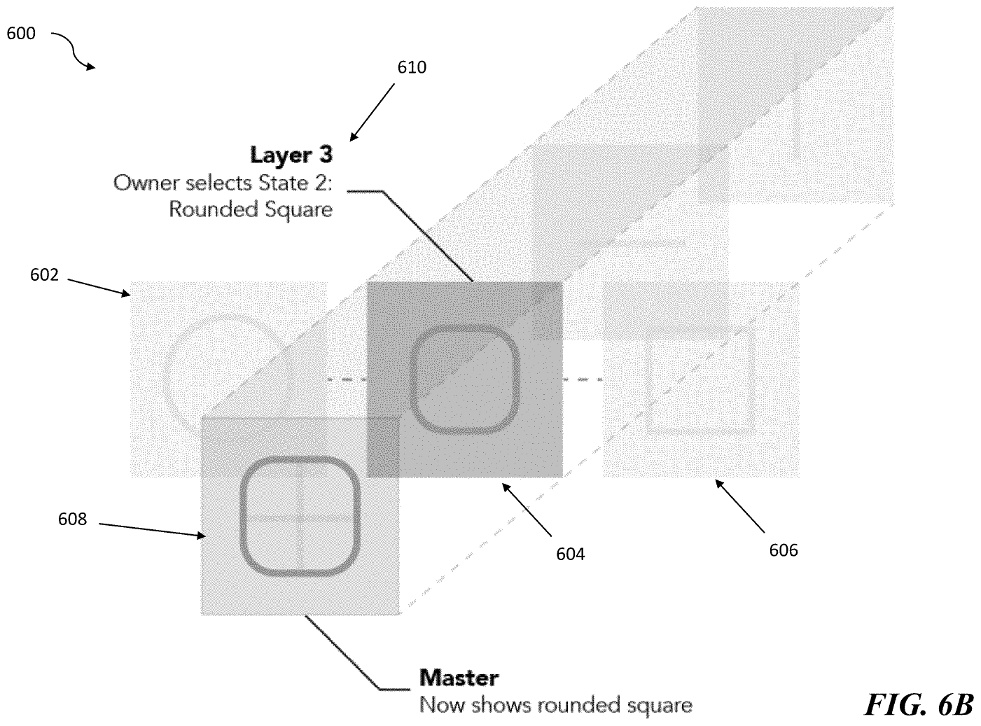

FIG. 6A is an exemplary elongated view 600 of a piece of programmable art. The view 600 showcases a master image 608 and several states 602, 604, and 606 of a layer of the programmable art. Here layer 3 610 represented by token C and may have a different set of “states” that impact the master image 608. In FIG. 6A state 1, shown at state 602 may be the selected state for display at that moment. Each layer may have alternate states embedded in the token data. The layer owner may have the sole ability to change the current selected state.

FIG. 6B is an exemplary elongated view 600 of a piece of programmable art. The view 600 showcases a master image 608 and several states 602, 604, and 606 of the programmable art. In FIG. 6B, layer 3 610 owner may decide to display state 2 at 604 and the master image 608 may reflect this change automatically without additional interaction from the user.

FIG. 7 is an exemplary token manipulation diagram showing a process for interacting with programmable art. The token manipulation system 700 may include a master token 702, a smart contract 704, a renderer 706, a set of user devices 708, and a set of layer tokens 710, 712, and 714. In some embodiments of the system 700 there may be additional, or fewer, components to the system. The layer tokens 710, 712, and 714 may be stored at the master token 702 that is in turn stored at a smart contract 704. The smart contract 704 may be stored on a distributed ledger network, such as the Ethereum blockchain, or any other suitable distributed ledger network. The master token 702 and smart contract 704 may be communicatively coupled to each other as well as to the renderer 706. The renderer 706 in turn may be communicatively coupled to the set of user devices 708.

In some embodiments, a master token 702 may hold a uniform resource identifier (“URI”) that holds instructions for how to render the overall image composed of the set of layer tokens. The URI may include the order of the layers and all of the images for the states of the layers. The master token 702 is part of the smart contract 704. The smart contract 704 may hold parameters and permissions of token owners/holders. The smart contract 704 allows token owners to change values within these parameters. The renderer 706 is configured to regularly check the status (e.g. every couple of seconds) of the smart contract 704 for updates that are submitted by the token holders.

In one embodiment, an owner of one of the layer tokens may submit a change to be implemented at the layer token they own via a signed distributed ledger transaction. The layer token holder may submit the change via one of the user devices at 708. The change may be submitted directly to the smart contract 704 and then subsequently to the master token 702 and affected layer token. The smart contract 704 verifies the layer token holder's permission to make changes to the layer token, and if the token holder has permission the smart contract 704 makes changes to the values for that token. Once the changes have been accepted the renderer 706, which is constantly monitoring the smart contract 704 for any changes to the underlying tokens, recognizes that there was a change and proceeds to rerender the image based on the new values. As part of the rerendering process the renderer 706 checks the master token 702 for instructions on how to interpret the new values submitted by the token holder. After the check, the renderer takes the results and updates so that all instances of the image show the newest render. As such, all the user devices in the set of user devices 708 will have access to and display the new image based on the changes.

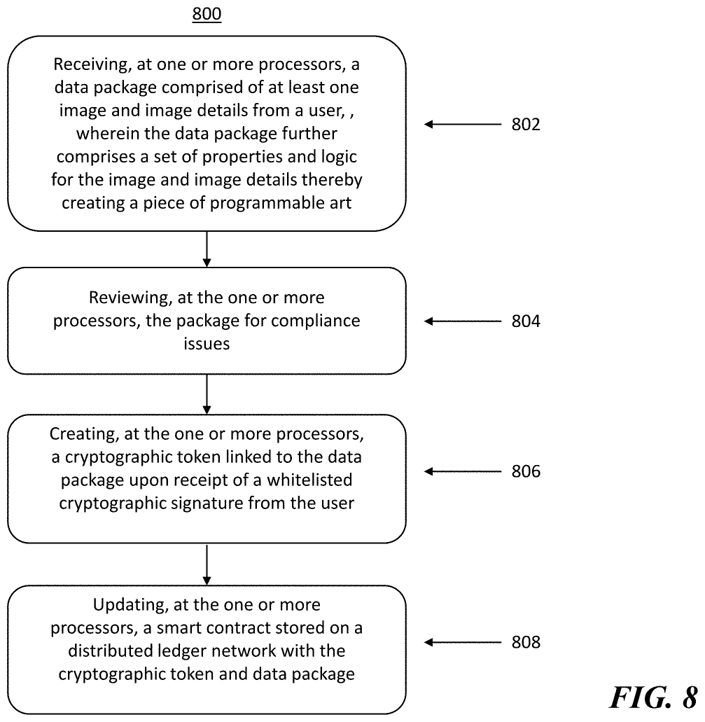

FIG. 8 is a block diagram of a computer-implemented method 800 for creating programmable art. In an exemplary embodiment, the computer implemented method for creating programmable art, may comprise: receiving, at one or more processors, a data package comprised of at least one image and image details from a user, wherein the data package further comprises a set of properties and logic for the image and image details thereby creating a piece of programmable art (block 802); reviewing, at the one or more processors, the package for compliance issues (block 804); creating, at the one or more processors, a cryptographic token linked to the data package upon receipt of a whitelisted cryptographic signature from the user (block 806); and updating, at the one or more processors, a smart contract stored on a distributed ledger network with the cryptographic token and data package (block 808). In some embodiments, there may be additional, or fewer, steps to the computer-implemented method.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirt and scope of the appended claims. For example. It is to be understood that the present technology contemplates that, to the extent possible, one or more features of any implementation can be combined with one or more features of any other implementation.

The methods and systems discussed herein may be implemented via one or more processing devices (e.g., a digital processor, a digital circuit designed to process information, an analog circuit designed to process information, a state machine, and/or other mechanisms for electronically processing information). The one or more processing devices may include one or more devices executing some or all of the operations of the methods in response to instructions stored electronically on an electronic storage medium. The one or more processing devices may include one or more devices executing some or all of the operations of the methods in response to instructions stored electronically on an electronic storage medium. The one or more processing devices may include one or more devices configured through hardware, firmware, and/or software to be specifically designed for execution of one or more of the operations of the methods.

The server(s) and client computing platform(s) may be communicatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s), client computing platform(s), and any other discussed third parties may be operatively linked via some other communication media.

A given client computing platform may include one or more processors configured to execute computer program modules. The computer program modules may be configured to enable a user associated with the given client computing platform to interface with the described systems and methods and/or provide other functionality attributed herein to client computing platform(s). By way of non-limiting example, the given client computing platform may include one or more of a desktop computer, a laptop computer, a handheld computer, a tablet computing platform, a Smartphone, a gaming console, a VR/AR headset or other device, and/or other computing platforms.

Server(s) may include electronic storage and one or more processors, and/or other components. Server(s) may include communication lines, or ports to enable the exchange of information with a Network and/or other computing platforms. Illustration of server(s) is not intended to be limiting. Server(s) may include a plurality of hardware, software, and/or firmware components operating together to provide the functionality attributed herein to servicer(s). For example, server(s) may be implemented by a cloud of computing platforms operating together as server(s).

The electronic storage media may comprise non-transitory storage media that electronically stores information. The electronic storage media may include one or both of system storage that is provided integrally (i.e., substantially non-removable) with server(s) and/or removable storage that is removably connectable to server(s) via, for example, a port (e.g., a USB port, a firewire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private Network, and/or other virtual storage resources). The electronic storage may store software algorithms, information determined by processor(s), information received from server(s), information received from client computing platform(s), databases and/or other information that enables server(s) to function as described herein.

Processor(s) may be configured to provide information processing capabilities in server(s). As such, processor(s) may include one or more of a digital processors, an analog processor, a digital circuit designed to process information, an analog circuit designed to process information, a state machine, and/or other mechanisms for electronically processing information. Although processor(s) may function as a single entity, in other implementations, processor(s) may include a plurality of processing units. These processing units may be physically located within the same device, or processor(s) may represent processing functionality of a plurality of devices operating in coordination. Processor(s) may be configured to execute instructions for applications, or modules, by software; hardware; firmware; some combination of software, hardware, and/or firmware; and/or other mechanisms for configuring processing capabilities on processor(s). As used herein, the term “module” may refer to any component or set of components that perform the functionality attributed to the module. This may include one or more physical processors during execution of processor readable instructions, the processor readable instructions, circuitry, hardware, storage media, or any other components.

The various messaging and data transfer described above may be accomplished with a REST API (or “RESTful” API). A RESTful API is an application program interface (API) that uses HTTP calls to request resources as opposed to functions. The function is embedded in the HTTP call through requests to GET, PUT, POST and DELETE, for example. The API spells out the proper way to request data, from an operating system or other application and allows management of customer data, sales orders, inventory, and products.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are in some embodiments directed to an improvement to computer functionality and may improve the functioning of conventional computers.

We claim:

1. A computer-implemented method for creating programmable art, comprising:
receiving, at one or more processors, a data package comprised of at least one image and image details from a user, wherein the data package further comprises a set of properties and logic for the image and image details thereby creating a piece of programmable art;
reviewing, at the one or more processors, the data package for compliance issues;
creating, at the one or more processors, a cryptographic token linked to the data package upon receipt of a whitelisted cryptographic signature from the user; and
updating, at the one or more processors, a smart contract stored on a distributed ledger network with the cryptographic token and data package.

2. The computer-implemented method of claim 1, wherein the image details for the at least one image comprise at least one description and a layer location for the at least one image.

3. The computer-implemented method of claim 1, wherein the set of properties and logic are configured to cause the smart contract and the piece of programmable art to update in response to input.

4. The computer-implemented method of claim 1, wherein reviewing the data package for compliance issues further comprises:
checking, at the one or more processors, the at least one image for intellectual property issues posed by the piece of programmable art.

5. The computer-implemented method of claim 1, wherein creating the cryptographic token linked to the data package upon receipt of the whitelisted cryptographic signature from the user further comprises:
checking, at the one or more processors, an address associated with a distributed ledger network against a blacklist of distributed ledger network addresses compiled by a government, non-governmental, or corporate entity.

6. The computer-implemented method of claim 1, further comprising:
updating, via the one or more processors, the programmable art and smart contract stored on the distributed ledger network in response to an external stimuli.

7. The computer-implemented method of claim 1, further comprising:
updating, via the one or more processors, the programmable art and smart contract stored on the distributed ledger network in response to receipt of a distributed ledger network transaction.

8. A system for creating programmable art, comprising:
a user device;
one or more servers; and
a distributed ledger network;
wherein the one or more servers are configured to:
review a data package comprised of at least one image and image details received from the user device, wherein the data package further comprises a set of properties and logic for the image and image details thereby creating a piece of programmable art;
review the data package for compliance issues;
create a cryptographic token linked to the data package upon receipt of a whitelisted cryptographic signature from the user device; and
update a smart contract stored on the distributed ledger network with the cryptographic token and data package.

9. The system of claim 8, wherein the image details for the at least one image comprise at least one description and a layer location for the at least one image.

10. The system of claim 8, wherein the set of properties and logic are configured to cause the smart contract and the piece of programmable art to update in response to input.

11. The system of claim 8, wherein the review of the data package for compliance issues further comprises:
the one or more servers further configured to check the at least one image for intellectual property issues posed by the piece of programmable art.

12. The system of claim 8, wherein the creation of the cryptographic token linked to the data package upon receipt of the whitelisted cryptographic signature from the user device further comprises:
the one or more servers further configured to check an address associated with a distributed ledger network against a blacklist of distributed ledger network addresses compiled by a government, non-governmental, or corporate entity.

13. The system of claim 8, wherein the one or more servers are further configured to:
update the programmable art and smart contract stored on the distributed ledger network in response to an external stimuli.

14. The system of claim 8, wherein the one or more servers are further configured to:
update the programmable art and smart contract stored on the distributed ledger network in response to receipt of a distributed ledger network transaction.

15. A tangible machine-readable medium comprising instructions for creating programmable art, to cause a machine to at least:
receive a data package comprised of at least one image and image details from a user, wherein the data package further comprises a set of properties and logic for the image and image details thereby creating a piece of programmable art;
review the package for compliance issues;
create a cryptographic token linked to the data package upon receipt of a whitelisted cryptographic signature from the user; and
update a smart contract stored on a distributed ledger network with the cryptographic token and data package.

16. The tangible machine-readable medium of claim 15, wherein the image details for the at least one image comprise at least one description and a layer location for the at least one image.

17. The tangible machine-readable medium of claim 15, wherein the set of properties and logic are configured to cause the smart contract and the piece of programmable art to update in response to input.

18. The tangible machine-readable medium of claim 15, wherein review the data package for compliance issues further comprises:
check the at least one image for intellectual property issues posed by the piece of programmable art.

19. The tangible machine-readable medium of claim 15, wherein create the cryptographic token linked to the data package upon receipt of the whitelisted cryptographic signature from the user further comprises:
check an address associated with a distributed ledger network against a blacklist of distributed ledger network addresses compiled by a government, non-governmental, or corporate entity.

20. The tangible machine-readable medium of claim 15, further comprising:
update the programmable art and smart contract stored on the distributed ledger network in response to an external stimuli.
